(19) United States
(12) Patent Application Publication
(10) Pub. No.: US 2002/0030882 A1
(43) Pub. Date: Mar. 14, 2002

(54) Uv-reflecting interference layer system

(76) Inventors: Bruno Vitt, Aachen (DE); Jergen Blankenburg, Osterode (DE); Karl-Heinz Dasecke, Gruenenplan (DE); Birgit Lintner, Mainz (DE)

Correspondence Address: Charles N J Ruggiero Esq, Ohlandt Greeley Ruggiero & Perls L L P, One Landmark Square, 9th Floor, Stamford, CT, 06901-2682, US

(21) Appl. No.: 09/514,437

(22) Filed: Feb. 28, 2000

(30) Foreign Application Priority Data
Dec. 22, 1999 (DE) 199 62 144.6

(51) Int. Cl. G02B 1/00

(52) U.S. Cl. 359/350

(57) ABSTRACT

The invention concerns a UV-reflecting interference layer system for transparent substrates with broadband antireflection coating in the visible wavelength region. The invention is characterized by the fact that the interference layer system has at least four individual layers. The sequential layers have different indices of refraction and the individual layers have inorganic materials that are stable to UV and temperature.

### CLAIM OF PRIORITY

Priority is hereby claimed under Title 35, United States Code, §119 from German Application 199 62 144.6, filed on Dec. 22, 1999.

### BACKGROUND OF THE INVENTION

1. Field of the Invention

The present invention concerns a UV-reflecting interference layer system for transparent substrates with broadband antireflection coating in the visible wavelength region, a process for the coating of a substrate with such a layer system, as well as the use of such coating systems in different fields of application.

2. Description of the Prior Art

At the present time, glass antireflection coatings that are known for the visible spectral region, for example, MIROGARD or AMIRAN antireflection coatings of the Schott-DESAG AG, Grünenplan, are interference filters comprised of three layers, wherein first a layer with an intermediate index of refraction is deposited, on which a layer with high refraction index, for the most part TiO₂, is applied, followed by a layer with low refraction index, for the most part SiO₂ or MgF₂. A mixture of SiO₂ and TiO₂, but also Al₂O₃, is used as the layer with intermediate refraction index. Such three-layer antireflection coatings are deposited onto spectacle glasses, onto monitors, onto window glass, for example, as plate glass for show windows, onto lenses to be coated, etc.

In most cases, these filters comprise a blue-violet or green residual reflection. With a perpendicular light incidence, the reflection characteristic of glasses coated on both sides is characterized in that the reflection for example, amounts to less than 1% within the wavelength interval of approximately 400-700 nm, but outside this region, the reflection increases to values of up to approximately 30% (V or W-shaped characteristic), thus way above the 8% of uncoated glass.

Reference is made to the following documents with respect to the state-of-the-art, the disclosure content of which is included to the full extent in the present application.

D1: H. Schröder, “Oxide Layers Deposited from Organic Solutions”, in Physics of Thin Films, Academic Press, New York, London Vol. 5, (1969), pp. 87-140.

D2: H. Schröder, Optica Acta 9, 249 (1962)

D3: W. Geffken, Glastech. Ber. 24, p. 143 (1951)

D4: H. Dislich, E. Hussmann, Thin Solid Films 77 (1981), pp. 129-139.

D5: N. Arfsten, R. Kaufmann, H. Dislich, Patent DE 3,300,589 C2.

D6: N. Arfsten, B. Lintner et al., Patent DE 4,326,947 C1.

D7: A. Pein, European Patent 0 438,646 B1.

D8: I. Brock, G. Frank, B. Vitt, European Patent 0 300,579 A2.

D9: Kienel/Frey (eds.), “Dunnschicht-Technologie”, VDI-Verlag, Dusseldorf (1987).

D10: R. A. Häfer, “Oberflächen- und Dunnschicht-Technologie”, Teil 1, “Beschichten von Oberflächen”, Springer-Verlag (1987),

It is a disadvantage in such systems that when viewing at an angle, which increasingly deviates from a perpendicular view, the characteristic shifts to continuously shorter wavelengths, whereby the long-wave reflection maximum falls into the visible region, and causes an undesired red component of the reflected light color.

### SUMMARY OF THE INVENTION

One objective of the present invention is thus to find an antireflection coating, whose residual reflection is low in an essentially broader wavelength region, thus approximately in the region from 400 to at least 800 nm with perpendicular incidence of light and which, in addition, is antireflective in a broadband manner at higher viewing angles. In many cases of application, such as in plate glass for show windows or glazings for pictures, a color-neutral appearance is desirable, particularly for different viewing angles.

In particular, for glazings for pictures such as those in museums, but also in the case of show window glazings, it is also desirable that an antireflective glass—that is as neutral in color as possible—simultaneously takes over the function of protection of the colors in the picture, or the natural or artificial fibers, as well as the colors of the show window displays, against ultraviolet light.

As is known, the UV component of sunlight or lamp light, particularly in the case of metal halide or in other gas-discharge lamps, but also in halogen lamps, is sufficient to unleash considerable damage over longer periods of time, such as discoloring or brittling of natural or artificial materials. A UV protection would even be desirable for glazings in offices or residences in order to greatly reduce the bleaching out of wood surfaces, curtains, upholstered furniture, etc. in the case of direct solar radiation, and thus, for example, to make possible an improved passive solar energy utilization. Current heat-protection glasses, which contain a thin silver layer, are not antireflective in the visible region, and also do not offer a sufficient UV protection, since thin silver layers are transparent in the UV region.

In the case of known antireflective soft glass, UV protection is achieved by the use of organic polymers as absorbers for UV light, for example, as laminated glass, whereby two panes of glass are laminated together with a PVB plastic foil of 380 nm thickness, for example, which is adapted in refraction index to the glass (glass MIROGARD-PROTECT of Schott-DESAG). Such glasses, however, are not temperature-stable under intense lamp light, for example, as lamp attachment plates, and also degrade due to intensive UV radiation. In addition to the above-named limitations, their three-layer anti-reflective coating on one side also makes the production of laminated glass expensive.

Another possibility is the use of UV-absorbing lacquer layers that are transparent to visible light, with a thickness of a few micrometers. Such lacquer coatings are also not stable relative to UV and temperature, and must still be made antireflective after applying onto the glass.

The task of the invention is thus to indicate a coating for a transparent substrate, particularly glasses, with which the above-described disadvantages can be overcome.

In particular, a UV filtering will be achieved, on the one hand, without the use of UV-unstable or temperature-unstable polymer foils or lacquers, and at the same time, on the other hand, an antireflective coating of the visible region that is essentially broader in band and more neutral in color will also be achieved.

With respect to the UV filtering, approximately the same characteristics will be achieved as in the case of foil or lacquer systems.

According to the invention, the technical problem is resolved by an interference layer system, which comprises at least four individual layers, whereby sequential layers have different indices of refraction, and the individual layers comprise UV-stable and temperature-stable inorganic materials.

Particularly preferred is an interference layer system of five layers with the structure glass +M1/T1/M2/T2/S, wherein the highly refractive material T at a wavelength of 550 nm has a refraction index in the range of 1.9-2.3; the low-refractive material S has a refraction index between 1.38 and 1.50; and the intermediate-refractive material M has a refractive index in the range of 1.6-1.8, with layer thicknesses of the individual materials in the range of 70 to 100 nm (M1), 30 to 70 nm (T1), 20 to 40 nm (M2), 30 to 50 nm (T2) as well as 90 to 100 nm (S).

In one configuration of the invention, titanium dioxide is used as the highly refractive material, silicon dioxide is used as the low-refractive material, and a mixture of these materials is used as the intermediate-refractive material.

In an alternative form of embodiment, instead of titanium dioxide, niobium oxide Nb₂O₅, tantalum oxide Ta₂O₅, cerium oxide CeO₂, hafnium oxide HfO₂, zirconium oxide ZrO₂ as well as their mixtures with titanium dioxide or with one another can be applied as the highly refractive layer; instead of silicon dioxide, aluminum oxide Al₂O₃, magnesium fluoride MgF₂, or mixtures of these materials can be used as the low-refractive layer; and instead of Ti—Si oxide mixtures, aluminum oxide Al₂O₃, zirconium oxide ZrO₂, or mixtures of these materials can be used as the intermediate-refractive layers.

In a first form of embodiment, soft glass can be used in the form of float glass, even in iron-impoverished form, as the transparent substrate.

Alternatively to this, hard glasses, particularly aluminosilicate and borosilicate hard glasses or quartz glass can be used as the substrate.

In addition to the interference layer system, the invention also makes available a process for depositing the same onto a substrate.

In a first configuration of the invention, the individual layers are applied by means of the dipping method or the spin process in the sol-gel technique.

Alternatively to this, the layers can be applied by means of cathode sputtering by means of physical vacuum metallizing, or by means of chemical vapor deposition, particular plasma-supported.

### BRIEF DESCRIPTION OF THE DRAWINGS

The invention will be described below on the basis of the figures.

The above set forth and other features of the invention are made more apparent in the ensuing Detailed Description of the Invention when read in conjunction with the attached Drawings, wherein:

FIG. 1 shows the reflectance over wavelength as a function of the angle of incidence of the MIROGARD antireflection coating of SCHOTT-DESAG, Grünenplan, according to the state-of-the-art.

FIG. 2 shows the reflectance over wavelength as a function of the angle of incidence of the AMIRAN antireflection coating of SCHOTT-DESAG, Grünenplan, according to the state-of-the-art.

FIG. 3 shows the transmittance of UV filters on soft glass according to the state-of-the-art as a function of the wavelength.

FIG. 4 shows the transmission spectrum of a system according to the invention according to Example 1 of embodiment.

FIG. 5 shows the transmission spectrum of a system according to Example 1 of embodiment with several panes.

FIG. 6 shows the reflection characteristic of a system according to the invention.

FIG. 7 shows the reflection characteristic of a system according to the invention with an angle of incidence φ=30°.

FIGS. 8a, 8b show the reflection characteristic of a system according to the invention with an angle of incidence φ=8°.

FIG. 9 shows the reflection characteristic of a system according to the invention according to Example 2.

FIG. 10 shows the reflection characteristic of a system according to the invention according to Example 3.

### DETAILED DESCRIPTION OF THE INVENTION

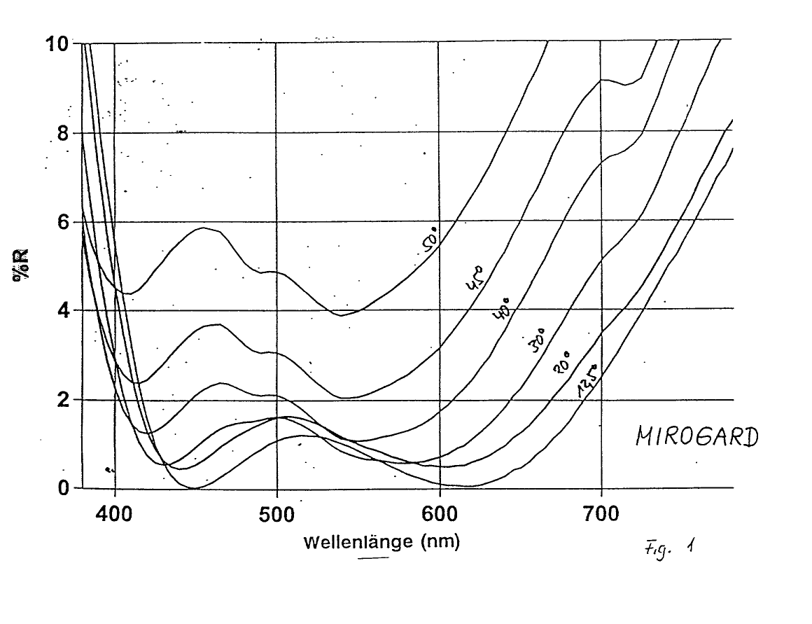

FIG. 1 shows the dependence of the reflectance R on the angle of incidence for the MIROGARD antireflection coating of Schott-DESAG. The measurements of the reflectance were plotted for different angles (12.5 to 50°) of the impinging light relative to the surface normal line.

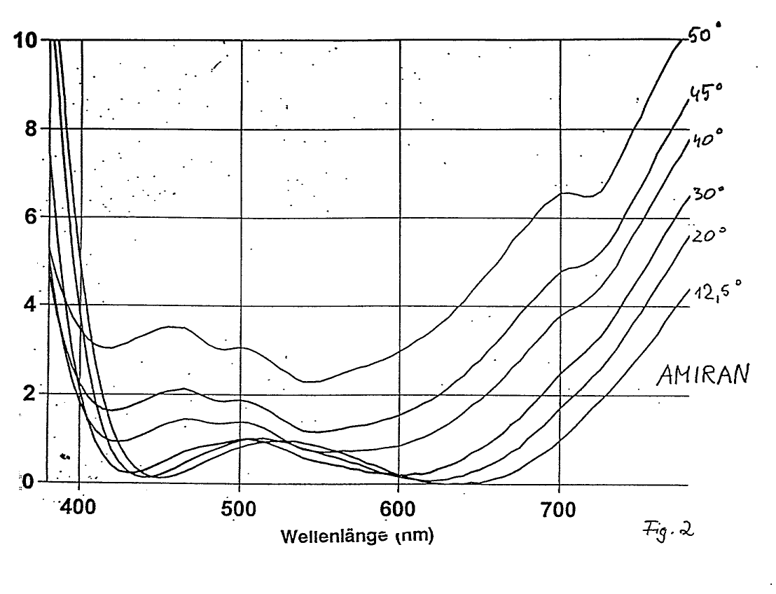

FIG. 2 shows the reflectance R for the three-layer antireflection coatings AMIRAN of the Schott-DESAG AG, Grünenplan.

The systems according to FIGS. 1 and 2 show a strong dependence of the reflectance on the angle of incidence of the light.

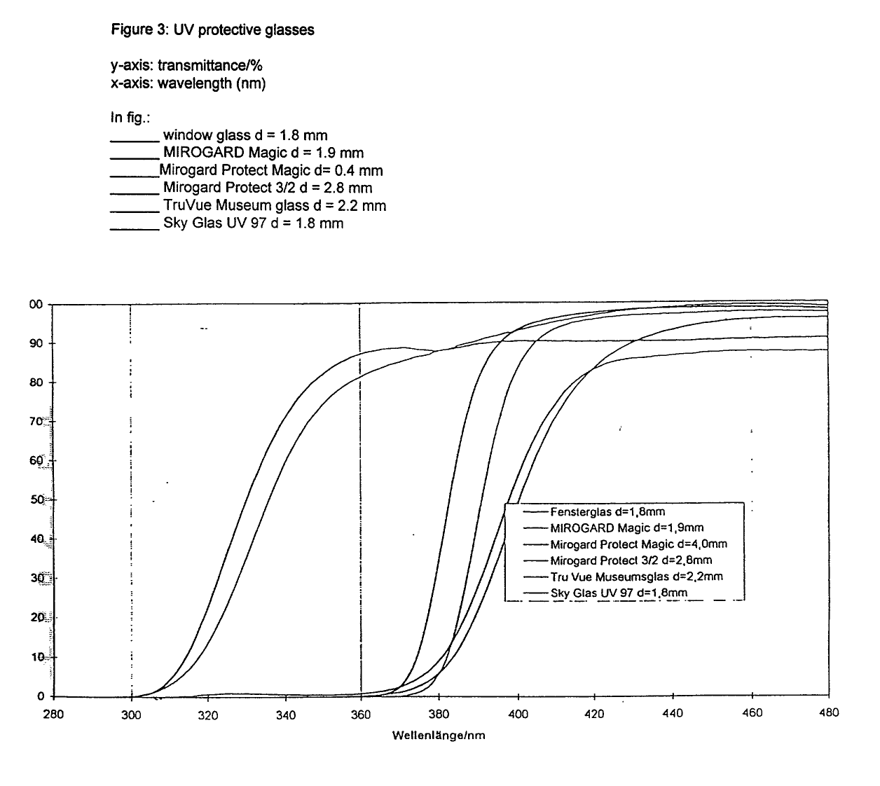

The transmittance of different UV filters according to the state-of-the-art on soft glass is shown as a function of wavelength in FIG. 3. Normal window glass is practically impermeable below 290 nm due to absorption, so that there is improved blocking only in the UV-B range, thus up to 315 nm; however, blocking particularly at 315 and 380 nm remains a technical problem. A MIROGARD three-layer antireflection coating without plastic foil introduces a slight improvement in the UV blocking by absorption and reflection when compared to uncoated glass. MIROGARD-PROTECT laminated glass is very effective as a UV-A blocker, and also TrueVue and Sky Glas, but TrueVue is very bluish in reflection and clearly yellow in transmission.

Examples 1-3 of a system according to the invention with improved properties, when compared with the state-of-the-art, will be described in detail below:

### EXAMPLE 1

### Color-Neutral Filter

A UV filter with combined broadband antireflection effect on soft glass (d=3 mm, not iron-impoverished) will be produced on both sides by means of the dipping method (sol-gel process), with the provision of providing an appearance that is as color-neutral as possible.

The coating onto both sides is comprised each time of five individual layers, and possesses the structure: glass +M*+T+M+T+S. The individual layers are applied identically on both sides each time in one dipping step.

The layers characterized by T contain titanium dioxide TiO₂; the covering layer designated as S contains silicon dioxide SiO₂; while the M layers are drawn each time from S and T mixed solutions.

The float glass substrate is carefully cleaned prior to coating. The dipping solutions are applied each time in rooms climate-controlled at 28° C. with an air humidity of 7 to 12 g/m³, and the drawing speeds for the individual layers M*/T/M/T/S amount to: 495/262/345/206/498 mm/min.

A heating process in air follows the drawing of each gel layer. The heating temperatures and heating times amount to 180° C./20 min after production of the first, second and third gel layers, and 440° C./30 min after the fourth and fifth layers.

In the case of the T layers, the dipping solution (per liter) is comprised of:

68 ml of titanium-n-butylate, 918 ml of ethanol (abs.), 5 ml of acetylacetone, and 9 ml of ethylbutyrylacetate.

The dipping solution for producing the S layer contains:

125 ml of silicic acid methyl ester, 400 ml of ethanol (abs.), 75 ml of H₂O (distilled), 7.5 ml of acetic acid; and after being left to stand for approximately 12 hours, it is diluted with 393 ml of ethanol (abs.).

The coating solutions for producing oxides with intermediate refraction index are prepared by mixing the S and T solutions. The layer designated as M in Example 1 is drawn from a dipping solution with a silicon dioxide content of 5.5 g/l and a titanium dioxide content of 2.8 g/l, and the corresponding oxide contents of the M* dipping solution amount to 11.0 g/l and 8.5 g/l, respectively

The wet-chemical sol-gel process applied in Example 1 with the dipping process permits the economical coating of large surfaces such as architectural glasses with interference filters, wherein the possibility of coating on both sides in one working cycle and the preparation of mixed oxides with the desired refraction index each time are of great advantage.

Panes can be coated either on both sides or also only on one side after covering one side of the glass.

Alternative coating methods are physical vacuum metallizing in high vacuum and its further developments relative to ion and plasma support and cathode sputtering.

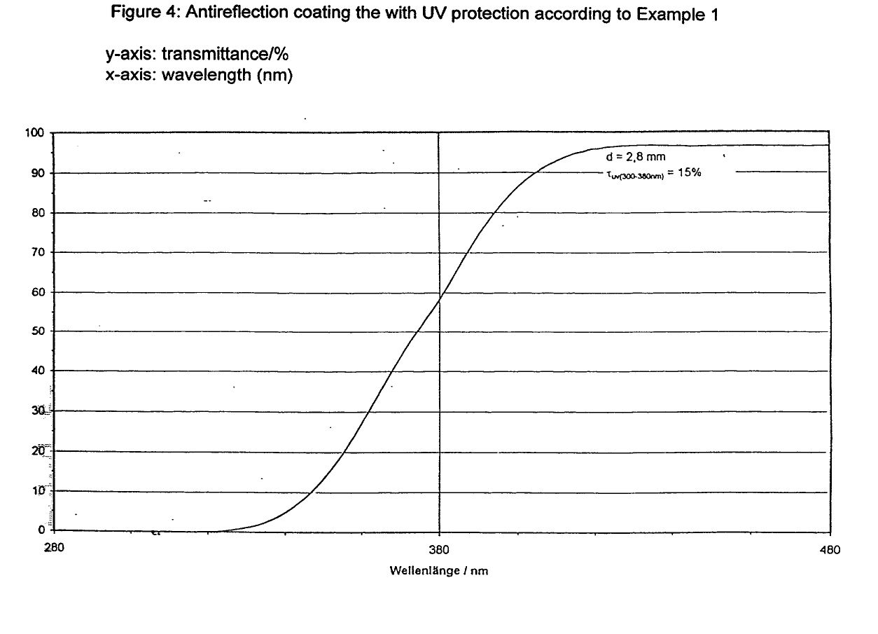

FIG. 4 shows the transmission spectrum of a filter according to the invention in the wavelength region of 280 to 480 nm, produced according to Example 1 (color-neutral filter). Even without the use of polymeric materials, the dangerous UV-B region is completely blocked, and the UV-A region is blocked by more than 2/3^{rds}, whereby only the less dangerous region of 340-380 nm is approximately 1/3^{rd} permeable. It is to be noted that the harmfulness of UV radiation increases continuously toward shorter wavelengths.

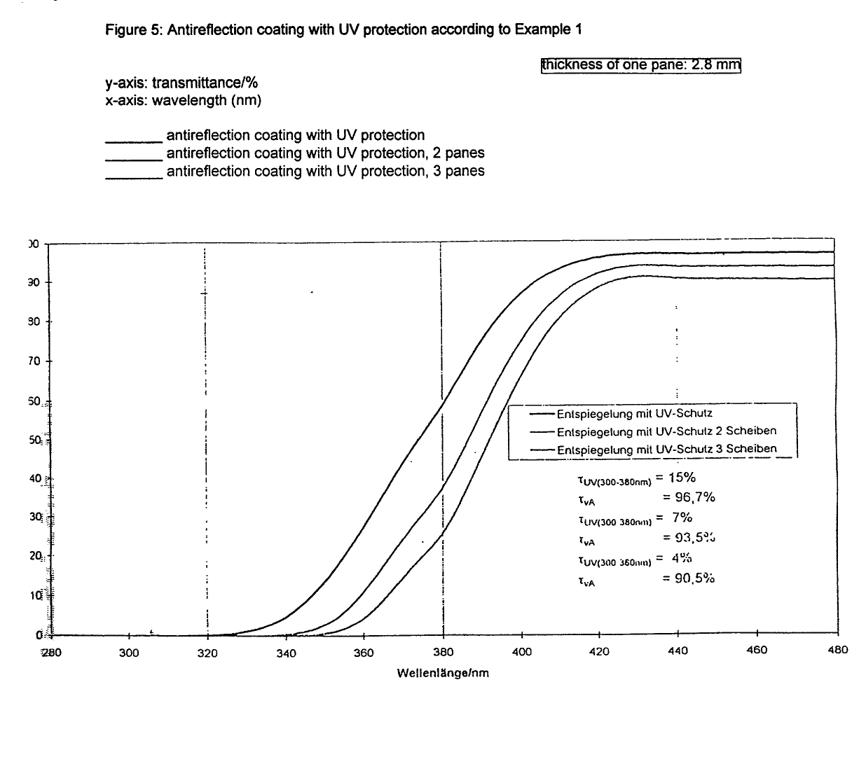

The transmittance in the wavelength range of 300 to 380 nm amounts to 15%; compared with an uncoated glass pane (approximately 60%), this is a UV reduction by a factor of 4. In the case of building glazings, of course, for the most part double panes and, less frequently, triple panes are used. The use of multiple panes improves the UV protection considerably, as shown in FIG. 5.

In the case of double panes, with each pane provided on both sides with the UV filter according to the invention, the transmittance in the range of 300-380 nm decreases to 7%, while a value of 4% was measured for triple panes. At the same time, the losses of reflection in the range of visible sunlight amount to only 1% for single panes, and approximately 2% and 3% for double and triple panes, for these architectural glazings. Compared with uncoated glasses, this means a reduction of reflection losses by an absolute 7% for single panes, and 14 and 21% for double and triple panes.

In particular, for glazings of museums and specialized textile stores, a new state-of-the-art is created herewith, since the 5-layer filter according to the invention represents only a relatively small increased expenditure when compared to the three-layer solution.

In addition, the filter according to the invention also solves the task of simultaneously creating a color-neutral antireflection coating, which also guarantees a color-neutral antireflection coating under greater viewing angles, due to the large width of the region of low reflection.

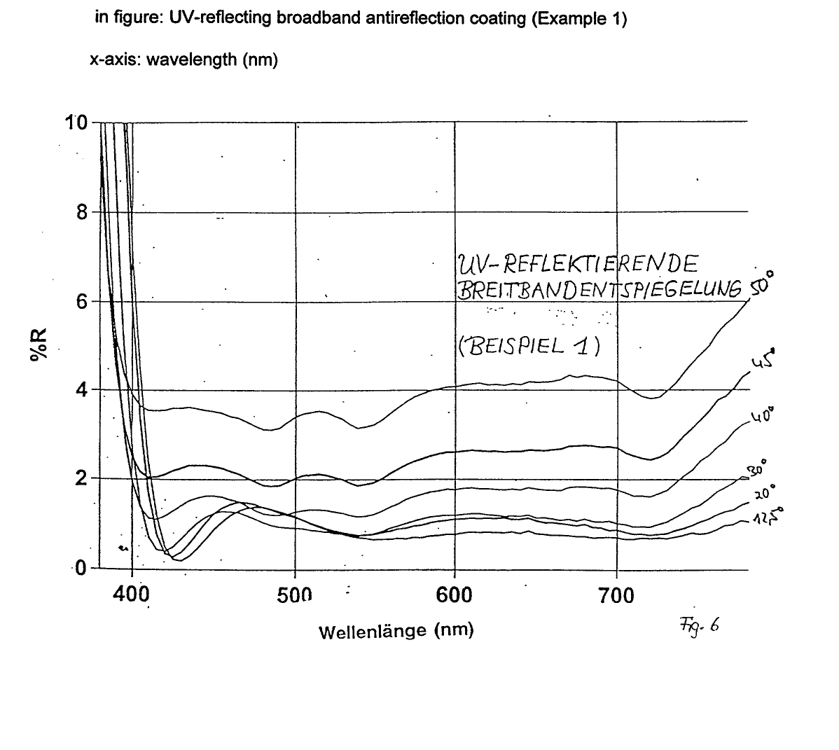

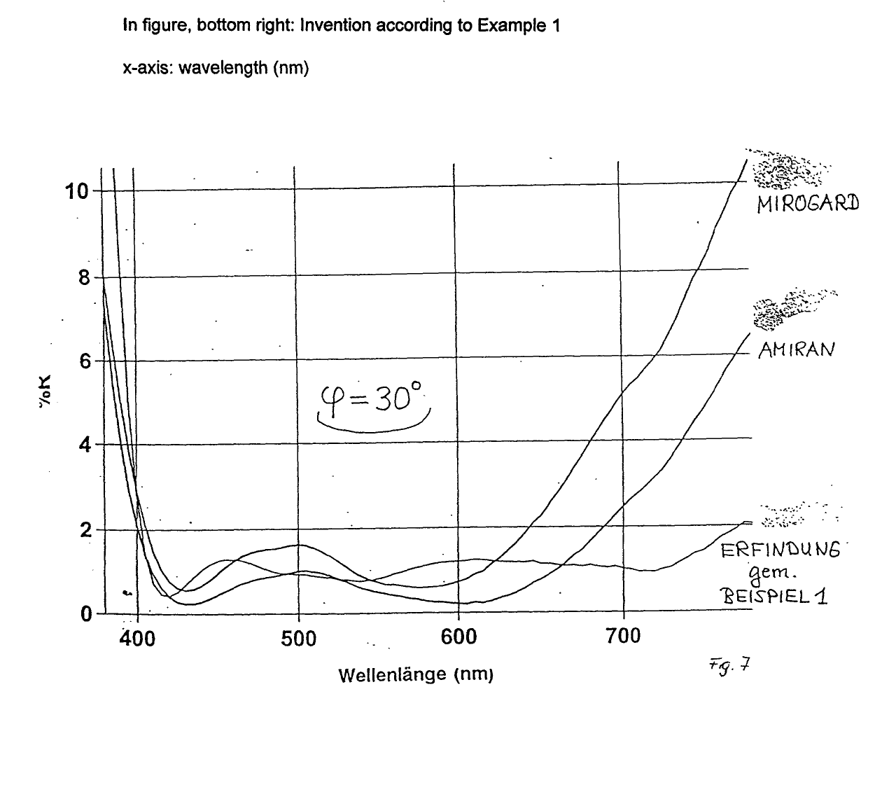

FIG. 6 shows the measured reflection characteristic of the filter according to the invention in the visible region from 380 to 780 nm as a function of the viewing angle (12.5-50°). A comparison with FIGS. 1 and 2 demonstrates the superiority of the solution according the invention compared with MIROGARD and AMIRAN with respect to broadbandedness, particularly also under larger angles of viewing. This is clear also from FIG. 7 by comparison of the filter according to the invention with these three-layer solutions for a solid angle of observation of 30°.

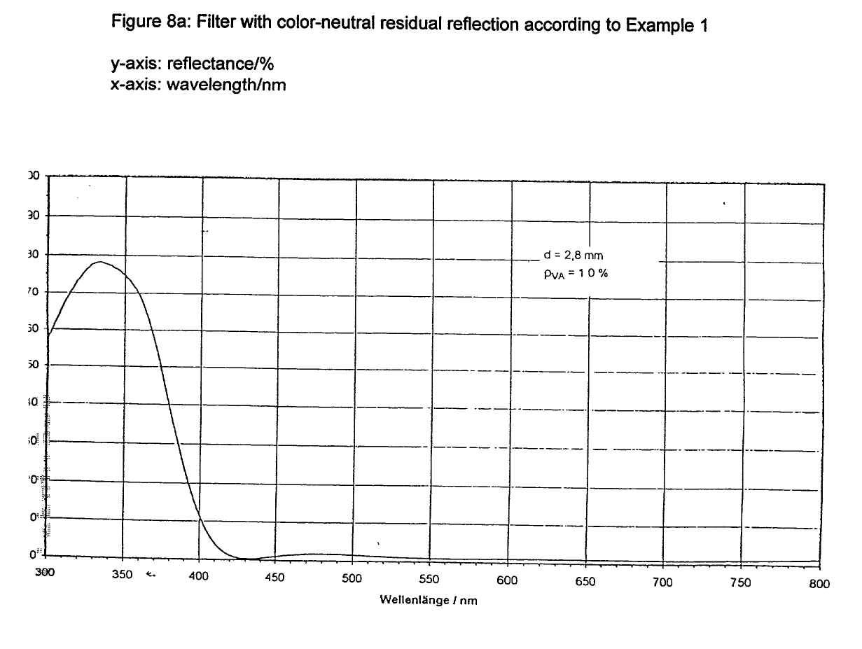

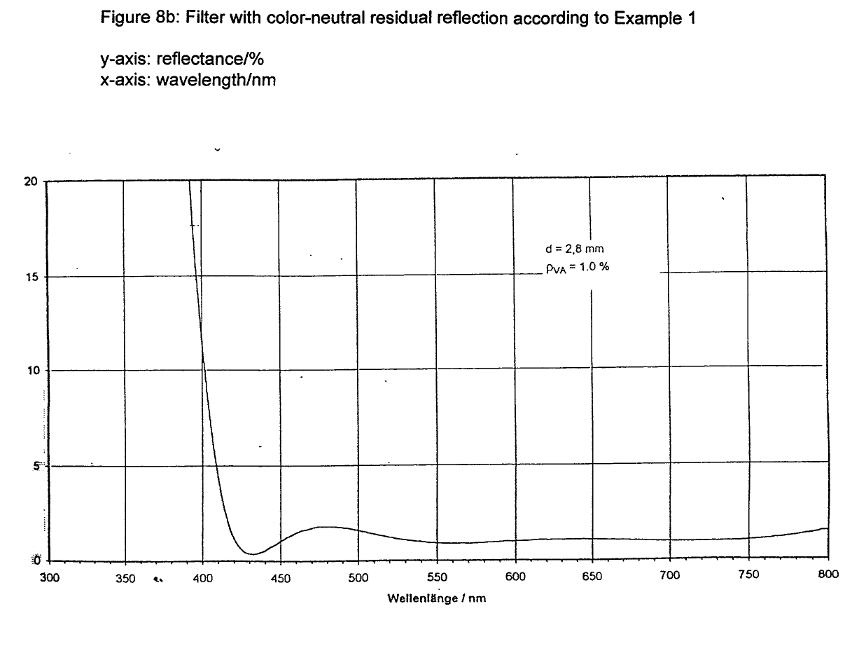

FIGS. 8a and 8b show the reflection spectrum for a viewing angle of 8° with different scales of R, and a wavelength region particularly enlarged in the UV direction: The average degree of reflection in the range of 400 to 800 amounts to 1%, and the subjective color impression is essentially more neutral, and this is true for large viewing angles of more than 30°, than in the case of all conventional three-layer antireflection coatings.

As FIG. 8a shows, the blockade effect of the UV filter according to the invention is based predominantly on reflection and less on absorption (UV reflector).

The thus-produced optical filters show not only the above-described transmission and reflection characteristic that is dependent on wavelength, but are characterized particularly by a high optical quality, are free of cracks, opacities and light scatter, and mediate a very color-neutral impression in reflection. They show particularly, however, even in transmission, no color-falsifying effect, which is very important, for example, for picture glazings.

The following lifetime and application tests with respect to application in inside rooms were conducted with the filters produced according to Example 1:

Boiling test (DIN 51 165), water-of-condensation constant−climate (DIN 50 017), salt spray mist test (DIN 50 021), Cass test (copper chloride+acetic acid+NaCl)

and for external application;

Water-of-condensation stability test, acid resistance test, abrasion resistance test (each time specification class A).

The glasses coated according to the invention withstand the tests conducted here and can be applied both in inside rooms, as well as externally, for example, as architectural glazings.

The invention will be explained below on the basis of two other examples:

### EXAMPLE 2

### Green Anitreflection Coating

A UV filter with combined broadband antireflection effect is produced on soft glass, analogously to Example 1, but with the provision of a green residual reflection color; of course, the first layer (M*) from Example 1 is now replaced by layer M# which is drawn from a silicon-titanium mixed solution with modified composition. This solution has a silicon dioxide content of 11.0 g/l and a titanium dioxide content of 5.5 g/l.

The thus-prepared M# layer has a somewhat smaller index of refraction when compared with M*, due to the relatively low titanium content.

The following are now selected as drawing speeds for the individual layers

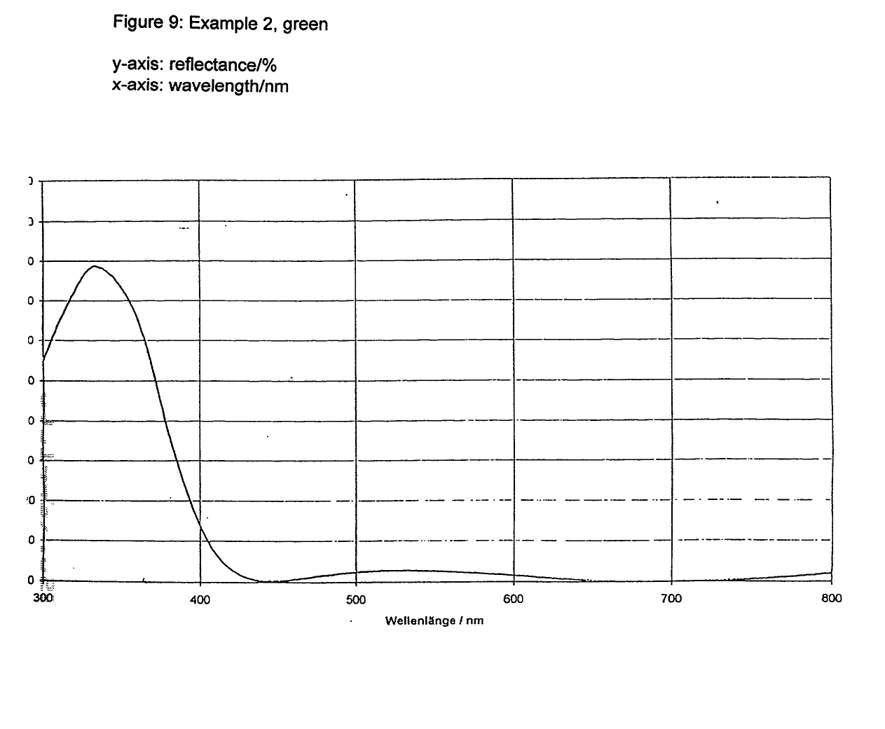

M#/T/M/T/S: v=540/262/345/206/500 mm/min, wherein an optical filter is obtained with a reflection characteristic according to FIG. 9, which differs from the filter of Example 1 essentially only by the changed residual reflection in the visible region. Other properties of the filter correspond to those of Example 1.

### EXAMPLE 3

### Blue-Violet Antireflection Coating

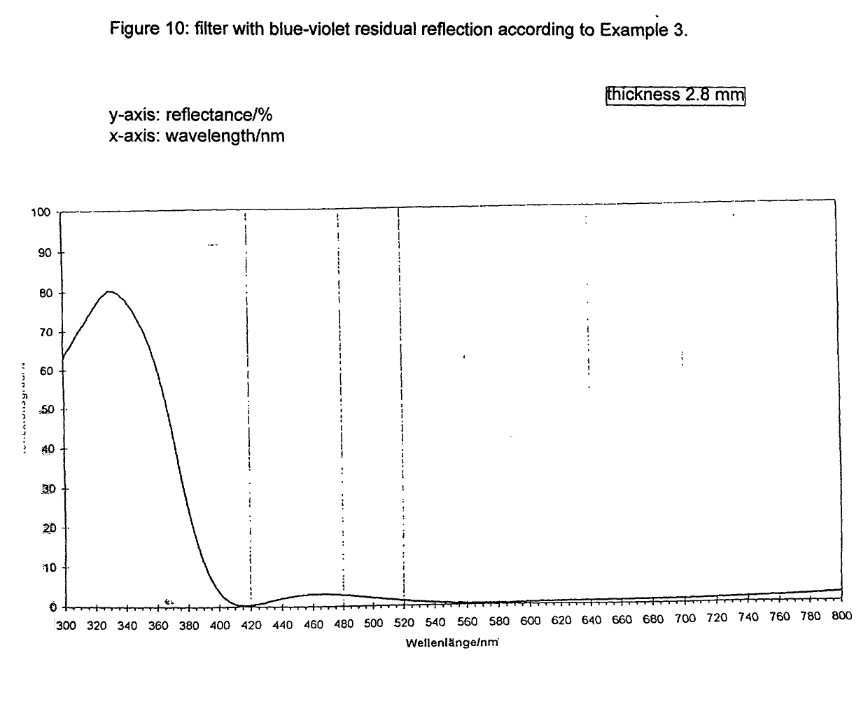

The filter according to the invention, but with blue-violet color of residual reflection, is produced with the process and also the individual layers according to Example 1, but with the following drawing speeds for M*/T/M/T/S: v=525/247/302/194/470 mm/min. In this way, a filter is obtained with a reflection characteristic corresponding to FIG. 10. Except for the modified color impression of the residual reflection, the other properties of the filter correspond to those of embodiment Examples 1 and 2.

For the first time a coating is indicated by the invention, which preferably produces an antireflection coating in a color-neutral manner for the glass-air boundaries in the visible wavelength region (380-780 nm), and at the same time considerably improves the UV protection properties of transparent substrates in the wavelength region of UV-A (315-380 nm) and UV-B (280-315 nm).

In addition to the coating of glass panes, fields of application of the optical filter according to the invention also include the coating of light bulbs in the lighting industry, in order to increase in a color-neutral manner the emitted visible light, particularly also under larger emission angles, and at the same time to reduce the UV emission. This particularly concerns discharge lamps with quartz glass bulbs, for example, metal halide lamps, but to a lesser extent also halogen lamps with quartz or hard glass bulbs.

In addition, the coating of tube-shaped envelope bulbs for lamps with the filter according to the invention can be produced as well as the application of the filter to planar attachment plates of hard and soft glass.

Thus, while the invention has been particularly shown and described with respect to preferred embodiments thereof, it will be understood by those skilled in the art that changes in form and details may be made therein without departing from the scope and spirit of the invention.

We claim:

1. A UV-reflecting interference layer system for transparent substrates with broadband antireflection coating in the visible wavelength region, characterized in that the interference layer system comprises at least four individual layers, whereby sequential layers have different indices of refraction and the individual layers have inorganic materials that are stable to UV and temperature.

2. The interference layer system according to claim 1, wherein the inorganic materials are inorganic oxides.

3. The interference layer system according to claim 1, wherein the inorganic oxides are extensively transparent above a light wavelength of 320 nm.

4. The interference layer system according to claim 1, wherein the individual layers comprise one or more materials or mixtures of the following groups of inorganic oxides:
TiO₂, Nb₂O₅, Ta₂O₅, CeO₂, HfO₂, SiO₂, Al₂O₃, ZrO₂, as well as MgF₂.

5. The interference layer system according to claim 1, wherein the interference layer system comprises at least five individual layers with the following layer structure:
substrate/M1/T1/M2/T2/S, wherein:
substrate indicates the transparent substrate
M1, M2 indicate a layer with intermediate refraction index
T1, T2 indicate a layer with high refraction index
S indicates a layer with low refraction index.

6. The interference layer system according to claim 5, wherein for a reference wavelength of 550 nm, the indices of refraction of the individual layers lie in the following range:
n_{low}≦1.5
1.6<nᵢₙₜ<1.8
1.9≦n_{high}.

7. The interference layer system according to claim 6, wherein the layer thickness of the individual layers lies in the following range:
for layer M1: 70 nm≦d_{M1}≦100 nm
for layer T1: 30 nm≦d_{T1}≦70 nm
for layer M2: 20 nm≦d_{M2}≦40 nm
for layer T2: 30 nm≦d_{T2}≦50 nm
for layer S: 90 nm≦d_{S}≦110 nm.

8. The interference layer system according to claim 6, wherein the layers comprise the following materials:
the highly refractive layer with n_{high}: TiO₂
the low-refractive layer with n_{low} SiO₂
and the intermediate refractive layer with nᵢₙₜ: a mixture of TiO₂ and SiO₂.

9. The interference layer system according to claim 6, wherein the highly refractive individual layers with n_{high} comprise one or more of the following materials:
TiO₂, ZrO₂, Nb₂O₅, Ta₂O₅, CeO₂, HfO₂, as well as mixtures of these materials with, the low-refractive layers comprise the following materials:
Al₂O₃, SiO₂, MgF₂ or mixtures of these materials and the intermediate-refractive layers comprise one or more of the following materials: Al₂O₃, ZrO₂.

10. The interference layer system according to claim 1, wherein the transparent substrate is soft glass in the form of float glass, even in Fe-impoverished form.

11. The interference layer system according to claim 1, wherein the transparent substrate is a hard glass, particularly aluminosilicate and borosilicate hard glass.

12. The interference layer system according to claim 1, wherein the transparent substrate is quartz glass.

13. A process for the coating of a substrate, particularly a transparent substrate with a coating system according to claim 1, wherein the individual layers are applied by means of a dipping or spinning method in the sol-gel technique.

14. The process for the coating of a substrate, particularly a transparent substrate with an interference layer system according to claim 1, wherein the individual layers are produced by means of cathode sputtering, physical vacuum metallizing or chemical vapor deposition, particularly ion or plasma-supported.

15. The process according to claim 13, wherein the substrate is coated on both sides.

16. The process according to claim 13, wherein one side of the substrate is covered and the substrate is coated only on one side.

17. The interference layer system according to claim 1, wherein the interference layer system is used for the coating of panes for glazings.

18. The interference layer system according to claim 1, wherein the interference layer system is used for the coating of light bulbs in the lighting industry.

19. The interference layer system according to claim 1, wherein the interference layer system is used for the coating of tube-shaped envelope bulbs for lamps or attachment plates of hard or soft glass.
